(19) United States
(12) Patent Application Publication
(10) Pub. No.: US 2026/0178801 A1
(43) Pub. Date: Jun. 25, 2026

(54) System and method for simulating pollutant transportation

(71) Applicant: National Central University, Taoyuan City (TW)

(72) Inventors: Jui-Sheng Chen, New Taipei City (TW); Zhong-Yi Liao, Taipei City (TW); Ching-Ping Liang, New Taipei City (TW); Chen-Wuing Liu, Taipei City (TW); Cheng-Wen Chen, Tainan City (TW); Hong-Yan Liao, Taichung City (TW)

(21) Appl. No.: 19/001,435

(22) Filed: Dec. 25, 2024

(51) Int. Cl. G06F 30/28; G06F 111/10

(52) U.S. Cl. CPC G06F 30/28; G06F 2111/10

(57) ABSTRACT

A system for simulating pollutant transportation includes an import module, an analysis module, a simulation setting module and a simulation output module. The system is used to provide accurate simulation of pollutant transportation by adapting to different types of pollutants and environmental conditions, and is convenient for more accurate and timely decision-making in pollution control and environmental management. A method for simulating pollutant transportation is realized through elements of the system for simulating pollutant transportation.

### BACKGROUND OF THE INVENTION

### 1. Field of the Invention

The present disclosure is related to a data simulation technique, in particular related to a system and a method for simulating pollutant transportation.

### 2. Description of the Prior Art

Environmental pollution is a critical global issue, significantly impacting public health, ecosystems, and economic development. Among the various forms of pollution, the transport of pollutants poses substantial challenges to regulatory agencies and industries aiming to mitigate environmental degradation. Accurate prediction and monitoring of pollutant dispersion are essential to prevent long-term inform damage and remediation efforts. Conventional methods of pollutant tracking, such as manual sampling and laboratory analysis, are labor-intensive, time-consuming, and often provide incomplete spatial and temporal data.

Various modeling techniques have been developed to simulate pollutant transportation. However, existing technologies often fail to consider complex reactions between various pollutants and environmental conditions, thus making simulation of pollutant transportation inaccurate.

Therefore, there is an unmet need in the art to develop a system and a method for simulating pollutant transportation that can overcome the deficiencies of prior art.

### SUMMARY OF THE INVENTION

In view of the foregoing, a system for simulating pollutant transportation is provided. The system includes an import module, an analysis module coupled with the import module, a simulation setting module coupled with the analysis module, and a simulation output module coupled with the simulation setting module. The import module may be used to import in-situ observation data. The analysis module may be used to analyze the in-situ observation data and extract setting reference data from the in-situ observation data. The simulation setting module may be used to generate simulation setting data according to the setting reference data. The simulation output module may be used to generate simulation output data according to the simulation setting data.

Further provided is a method for simulating pollutant transportation. The method includes: an import module importing in-situ observation data, an analysis module analyzing the in-situ observation data and extracting setting reference data from the in-situ observation data, a simulation setting module generating simulation setting data according to the setting reference data, and a simulation output module generating simulation output data according to the simulation setting data.

In at least one embodiment of the present disclosure, the system and the method are adaptable to different types of pollutants and environmental conditions, and enable more accurate and timely decision-making in pollution control and environmental management.

These and other objectives of the present invention will be easily understood by those of ordinary skill in the art after reading the following detailed description of the embodiment that is illustrated in the various figures and drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a schematic diagram of a system for simulating pollutant transportation according to at least one embodiment of the present invention.

FIG. 2 is a schematic diagram of an analysis module according to at least one embodiment of the present invention.

FIG. 3 is a schematic diagram of a simulation setting module according to at least one embodiment of the present invention.

FIG. 4 is a flow chart of steps for performing simulation of pollutant transportation for an objective species via the system for simulating pollutant transportation according to at least one embodiment of the present invention.

FIG. 5 is a schematic diagram of interface displayed by a display module in response to operation of a geological determination unit according to one embodiment of the present invention.

FIG. 6 is a schematic diagram of interface displayed by the display module in response to operation of a hydrology determination unit according to one embodiment of the present invention.

FIG. 7 is a schematic diagram of interface displayed by the display module in response to operation of a species determination unit according to one embodiment of the present invention.

FIG. 8 is a schematic diagram of interface displayed by the display module in response to operation of a species setting unit according to one embodiment of the present invention.

FIG. 9 is a schematic diagram of interface displayed by the display module in response to operation of the species setting unit according to one embodiment of the present invention.

FIG. 10 is a schematic diagram of interface displayed by the display module in response to operation of an aquifer setting unit according to one embodiment of the present invention.

FIG. 11 is a schematic diagram of interface displayed by the display module in response to operation of a pollution source setting unit according to one embodiment of the present invention.

FIG. 12 is a schematic diagram of interface displayed by the display module in response to operation of an output setting unit according to one embodiment of the present invention.

FIG. 13 is a schematic diagram of interface displayed by the display module in response to operation of a simulation output module according to one embodiment of the present invention.

### DETAILED DESCRIPTION

The following descriptions of the embodiments illustrate implementations of the present disclosure, and those skilled in the art of the present disclosure can readily understand the advantages and effects of the present disclosure in accordance with the contents herein. However, the embodiments of the present disclosure are not intended to limit the scope of the present disclosure. The present disclosure can be practiced or applied by other alternative embodiments, and every detail included in the present disclosure can be changed or modified in accordance with different aspects and applications without departing from the essentiality of the present disclosure.

The features such as a ratio, structure, and dimension shown in drawings accompanied with the present disclosure are simply used to cooperate with the contents disclosed herein for those skilled in the art to read and understand the present disclosure, rather than to limit the scope of implementation of the present disclosure. Thus, in the case that does not affect the purpose of the present disclosure and the effect brought by the present disclosure, any change in proportional relationships, structural modification, or dimensional adjustment should fall within the scope of the technical contents disclosed herein.

As used herein, “comprising”, “including”, or “having” a specific element, unless otherwise specified, may include other elements such as components, ingredients, structures, regions, portions, devices, systems, steps, or connection relationships rather than exclude those elements.

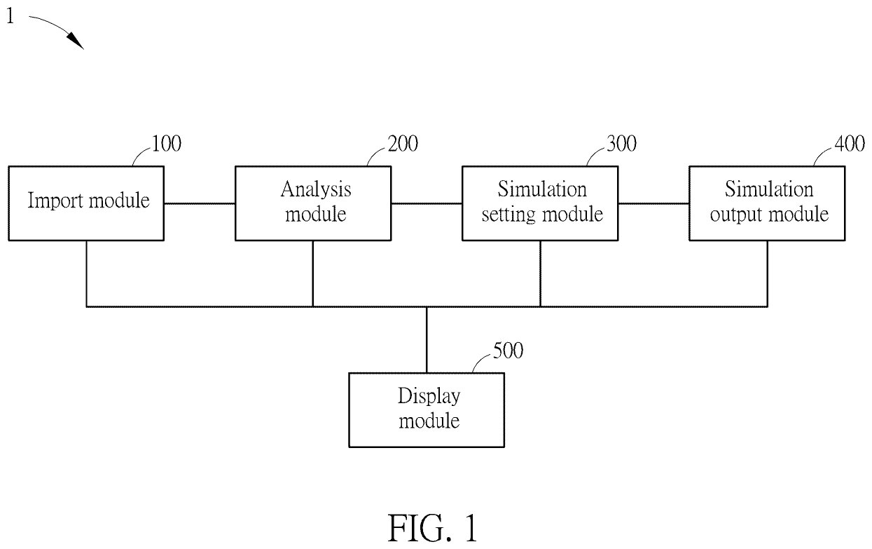

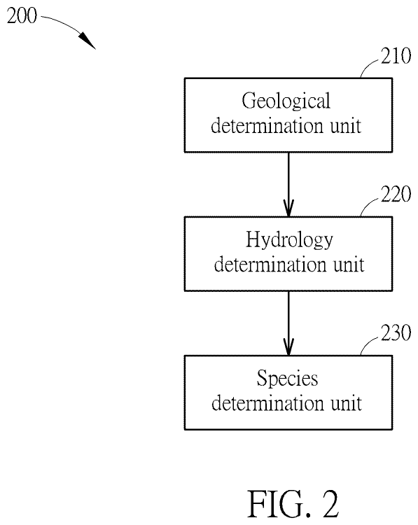

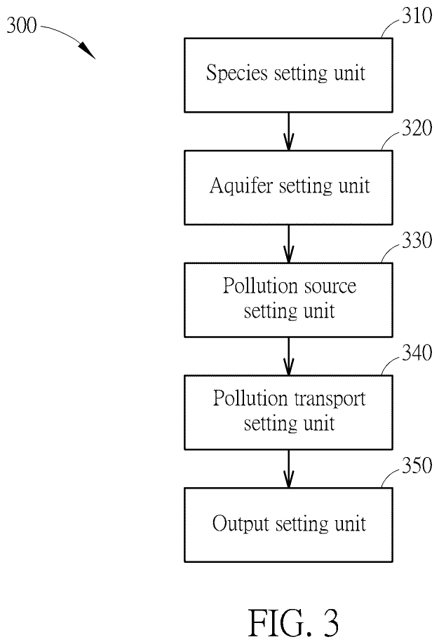

FIG. 1 is a schematic diagram of a system for simulating pollutant transportation 1 having elements including an import module 100, an analysis module 200, a simulation setting module 300, a simulation output module 400, and a display module 500. FIG. 2 is a schematic diagram of the analysis module 200 having elements including a geological determination unit 210, a hydrology determination unit 220, and a species determination unit 230. FIG. 3 is a schematic diagram of the simulation setting module 300 having elements including a species setting unit 310, an aquifer setting unit 320, a pollution source setting unit 330, a pollution transport setting unit 340, and an output setting unit 350. The above elements of the system for simulating pollutant transportation 1 may be connected with each other via any appropriate wired or wireless manner. Among all elements of the system for simulating pollutant transportation 1, display module 500 is coupled with all other elements and may be used to display operational interfaces and/or operation results of the system for simulating pollutant transportation 1.

The import module 100 may be used to import in-situ observation data regarding a specified location. The in-situ observation data may include drill core data, water level observation data, and pollutant concentration observation data of the specified location. The specified location may be an area selected/designated by a user via a map shown by the display module 500. The in-situ observation data may be imported from a government open-source data platform or field survey database.

The analysis module 200 is coupled to the import module 100 and may be used to analyze the in-situ observation data and extract setting reference data from the in-situ observation data. The details of the analysis module 200 extracting the setting reference data from the in-situ observation data may be explained through FIG. 2 and FIGS. 5 to 7, where the analysis module 200 may include a geological determination unit 210, a hydrology determination unit 220, and a species determination unit 230.

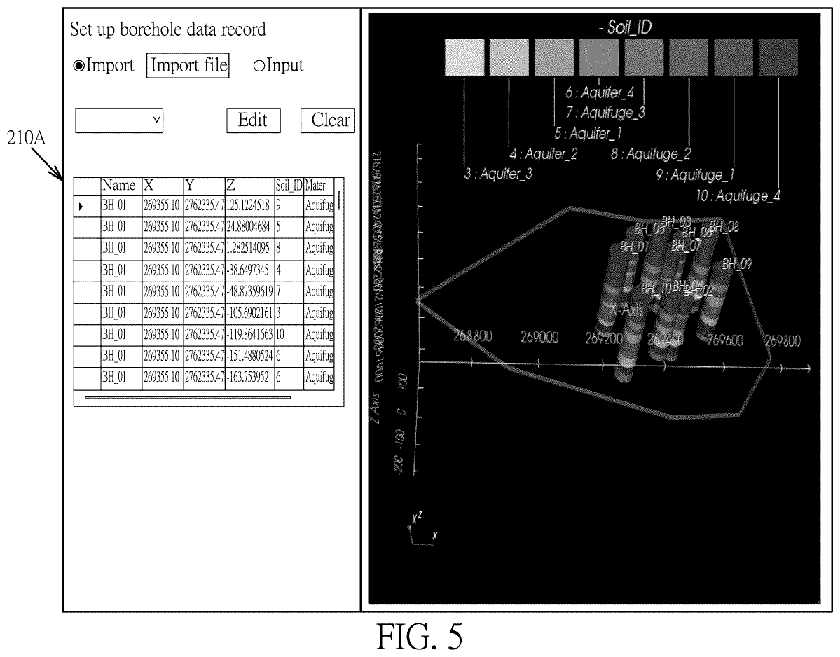

The geological determination unit 210 may be used to analyze the drill core data of the in-situ observation data and generate geological characteristics data of the specified location from the drill core data. The drill core data may include information sampled at core drilling wells within an area of the specified location, such as but not limited to, geological formation, chemical composition, mineral composition, texture, and color at specific depths of the core drilling wells. Therefore, information contained in drill core data may be analyzed by the geological determination unit 210 to generate geological characteristics data to reveal geological history and conditions regarding the area of the specified location. In the example shown in FIG. 5, the interface 210A displayed by the display module 500 indicates that geological characteristics data may be generated from drill core data of 10 core drilling wells within the area of the specified location.

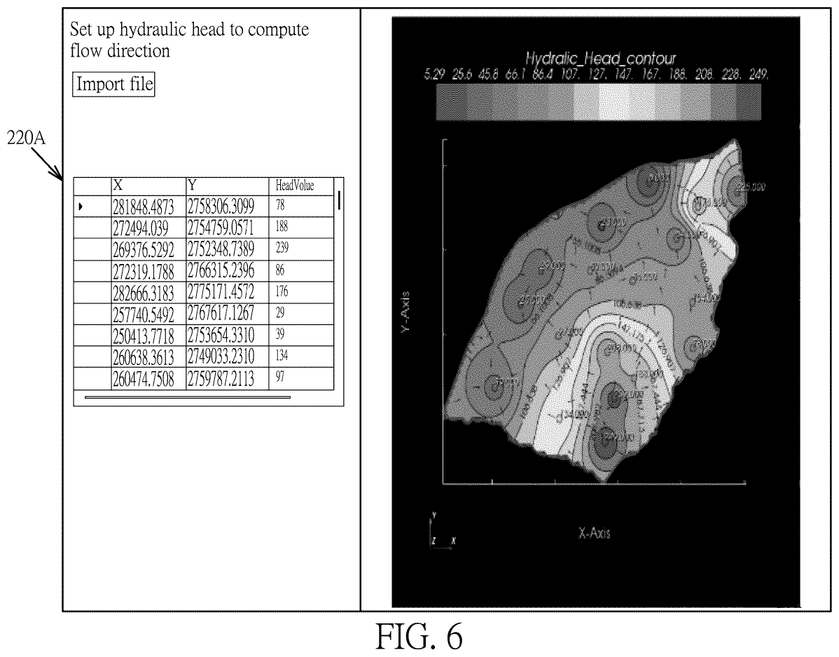

The hydrology determination module 220 may be used to analyze the water level observation data of the in-situ observation data and generate flow field data of the specified location. The water level observation data of the specified location may include information sampled at water observation wells within an area of the specified location, such as, but not limited to, groundwater level, trends of groundwater over time, groundwater quality, and dynamics of groundwater in response to various environmental factors observed in the water observation well. Therefore, the information contained in the water level observation data may be analyzed by the hydrology determination module 220 to generate flow field data to reveal hydraulic head, flow direction, and hydrograph of the flow field regarding the area of the specified location. In the example shown in FIG. 6, the interface 220A displayed by the display module 500 indicates that flow field data of the specified location may be used to locate the hydraulic heads and describe the flow field within the area of the specified location, with red representing regions with higher mechanic energy in body of water and blue representing regions with lower mechanic energy in body of water.

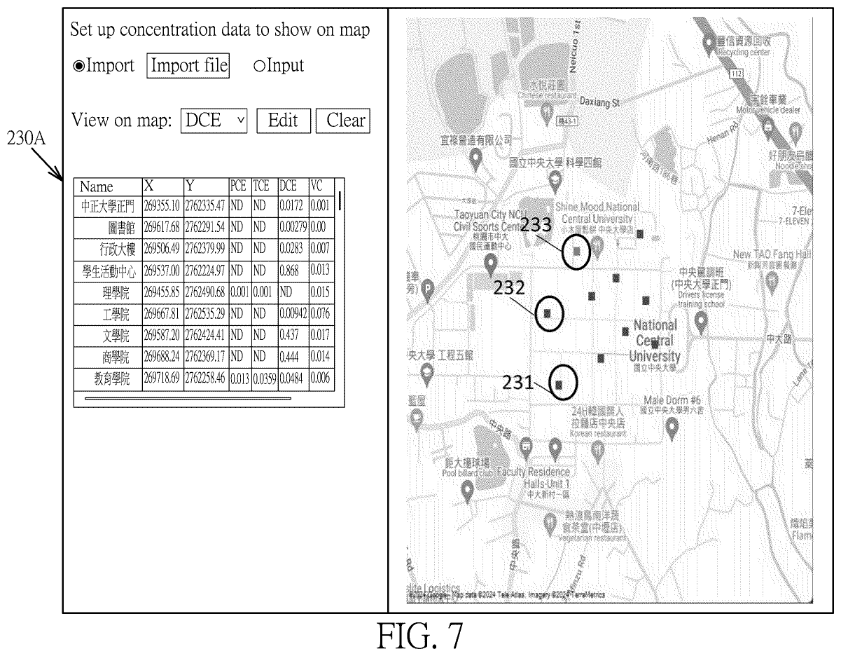

The species determination unit 230 may be used to analyze pollutant concentration observation data of the in-situ observation data and generate species concentration distribution data of the specified location. The pollutant concentration observation data may include information sampled at observation wells and/or contaminated sites within the area of the specified location, such as, but not limited to, type of pollutant, pollutant concentration, and location of pollutant observed from the observation wells and/or the contaminated sites. Therefore, the information contained in the pollutant concentration observation data may be analyzed by the species determination unit 230 to generate species concentration distribution data of the specified location. In the example shown in FIG. 7, the interface 230A displayed by the display module 500 indicates that the species concentration distribution data of the specified location may include pollutants (type of pollutant is not shown for clarity), concentration of the pollutants, and location of the pollutants labeled on the map representing area of the specified location, with species 231 labeled in red represents a pollutant with high concentration, species 232 labeled in green represents a pollutant with low concentration, and species 233 labeled in gray represents a pollutant with medium concentration.

Based on the above, the analysis module 200 may further generate the geological characteristics data from the geological determination unit 210, the flow field data from the hydrology determination module 220, and the species concentration distribution data from the species determination unit 230 into the setting reference data of the specified location and transmit to the simulation setting module 300 for further processing.

The simulation setting module 300 is coupled to the analysis module 200 and may be used to configure simulation setting data according to the setting reference data. The details of the simulation setting module 300 configuring the simulation setting data according to the setting reference data may be explained in FIG. 3 and FIGS. 8 to 12, where the simulation setting module 300 may include a species setting unit 310, an aquifer setting unit 320, a pollution source setting unit 330, a pollution transport setting unit 340, and an output setting unit 350.

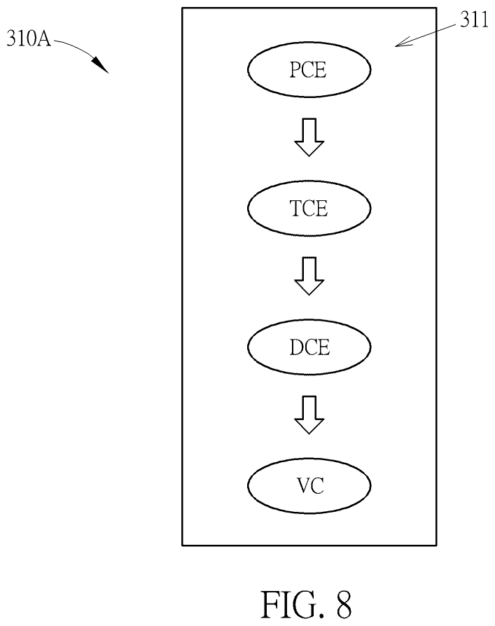

The species setting unit 310 may be used to configure an objective species and species degradation data of the objective species according to the species concentration distribution data of the specified location. For example, the user may select an objective species from all pollutants listed in the species concentration distribution data (e.g., as shown in FIG. 7) for simulation purpose, and the species setting unit 310 may generate the species degradation data of the objective species accordingly. In the example shown in FIG. 8, the interface 310A shown by the display module 500 indicates that in response to the objective species being set as a chlorinated solvent “tetrachloroethene (PCE),” the species degradation data of PCE is computed and output by the species setting unit 310, where the species degradation data may include an assumed straight degradation pathway of PCE having the pathway 311 of 4 decay levels: PCE→trichloroethene (TCE)→dichloroethylene (DCE)→vinyl chloride (VC), where each of the contaminants along the degradation pathway is situated in a one-to-one relationship. The straight degradation pathway of PCE may be considered by simulation output module 400 in later processing steps.

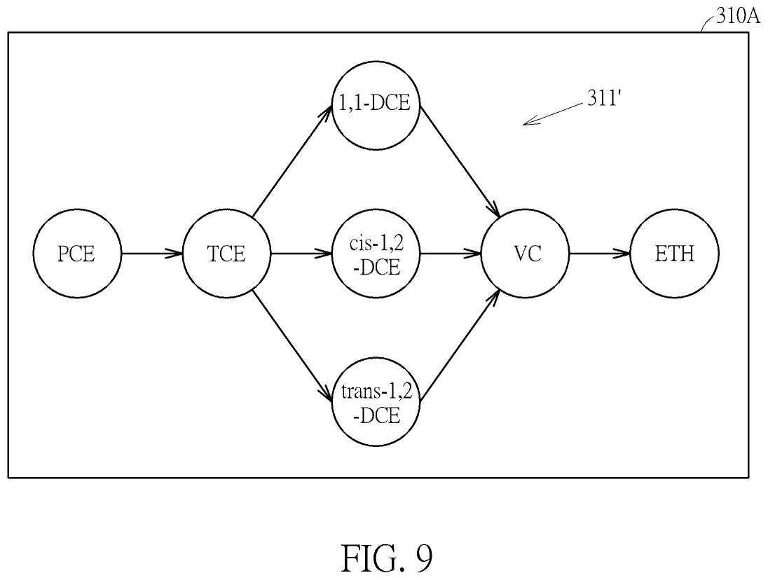

In another example, the species setting unit 310 may also generate the species degradation data of the objective species to be a complex degradation pathway of the objective species. In the example shown in FIG. 9, the interface 310A′ shown by the display module 500 indicates that in response to the objective species being set as “PCE,” the species degradation data of PCE is computed and output by the species setting unit 310, where the species degradation data may include an assumed complex degradation pathway of PCE having the pathway 311′ of 5 decay levels: PCE→TCE→DCE isomers (cis-1,2-DCE, trans-1,2-DCE and 1,1-DCE)→VC→ethane (ETH), where contaminants along the degradation pathway may be situated in a one-to-many or many-to-one relationship. The complex degradation pathway of PCE is beneficial for simulation output module 400 to consider coefficients in divergence pathways and convergence pathways during degradation of PCE and enable a much precise simulation.

In other examples, the species setting unit 310 may configure more than one objective species simultaneously, and species degradation data of more than one degradation path for the more than one objective species may be generated for purpose of simulation. The objective species may also include the contaminant yielded from the degradation pathway of the original objective species (e.g., TCE yielded from the degradation path of PCE). Further, the objective species may be configured to be pollutants other than PCE. Therefore, a more complex simulation of pollutant transport may generate a more accurate simulation result regarding the actual scenario of the specified location.

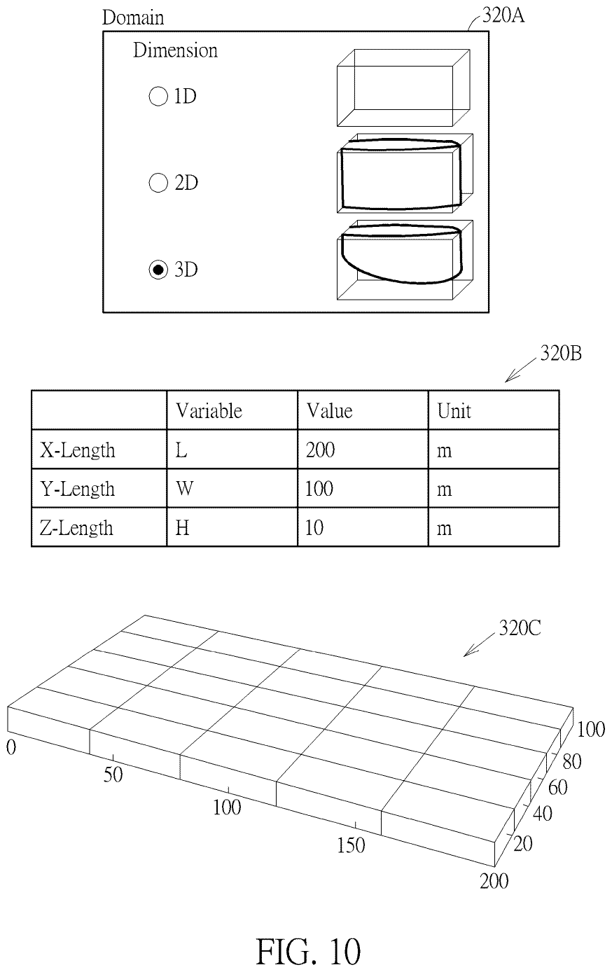

The aquifer setting unit 320 may be used to configure an aquifer domain of the specified location according to the geological characteristics data and flow field data of the specified location. In the example shown in FIG. 10, the user may select the aquifer domain to be simulated as a one-dimensional (1D) domain, a two-dimensional (2D) domain, or a three-dimensional (3D) domain through the interface 320A shown by the display module 500. Under the scenario that “3D” is selected for the aquifer domain, the interface 320B shown by the display module 500 may be used to configure the length (X-Length), width (Y-Length), and height (Z-Length) of the aquifer domain. Then, interface 320C may be used to display a digital twin of the aquifer according to the configurations in interface 320B. In the example shown in FIG. 10, the aquifer domain is set to be 200 m in length, 100 m in width, and 10 m in height. However, the length (X-Length), width (Y-Length), and height (Z-Length) of the aquifer domain may be set as arbitrary positive numeral values shorter than the length, width, and height of the area of the specified location. That is, the aquifer domain may be of any size according to simulation requirements.

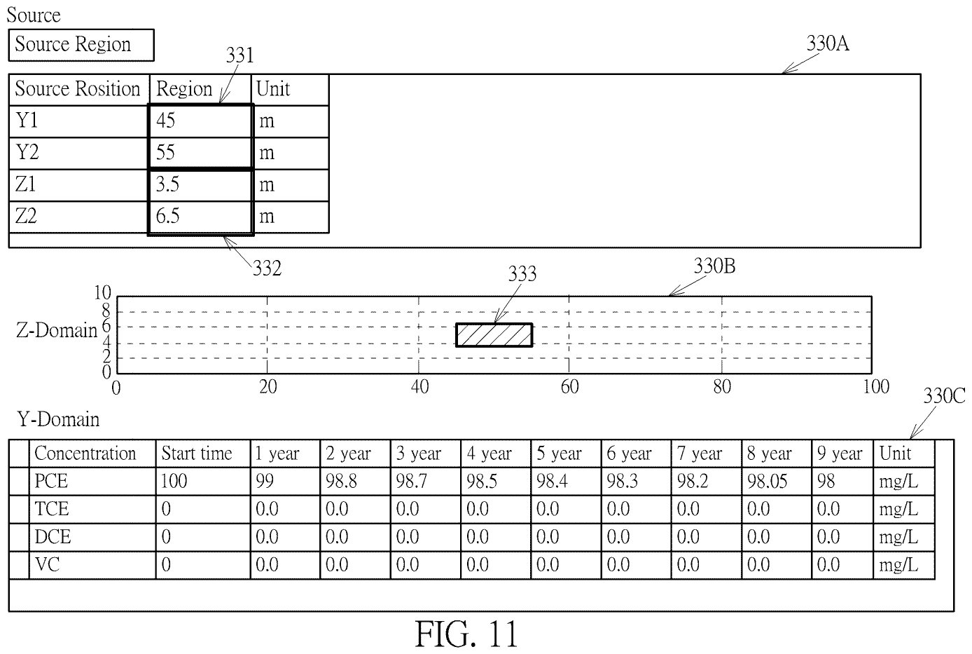

The pollution source setting unit 330 may be used to configure a pollution source region of the objective species within the aquifer domain according to the species concentration distribution data of the objective species and the aquifer domain. In the example shown in FIG. 11, given that the species concentration distribution data of the objective species may indicate the position of the objective species within the aquifer domain, and the user has selected to simulate transportation of pollutants along X axis (length) of the aquifer domain, the interface 330A displayed by the display module 500 may indicate that the pollution source region of the objective species within the aquifer domain to be at origin of X axis (not shown), position 331 between 45 m to 55 m on Y axis and position 332 between 3.5 m to 6.5 m of Z axis of the aquifer domain. Then, the interface 330B may be used to display a digital twin of the pollution source region 330 on the Y-Z axis plane of the aquifer domain. Further, the interface 330C may indicate the concentration change of the objective species at the pollution source region throughout a specified timeline. For example, the interface 330C in FIG. 11 may indicate that the concentration of PCE may drop from 100 mg/L at the start time to 98 mg/L in the (9)th year.

In other examples, the pollution source setting unit 330 may configure more than one pollution source regions of the objective species. Further, the pollution source regions may also be configured on positions of the X-Y axis plane, X-Z axis plane, X axis, Y axis, and/or Z axis of the aquifer domain. Therefore, a more complex simulation of pollutant transport may generate a more accurate simulation result regarding the actual scenario of the aquifer domain within the specified location.

The pollution transport setting unit 340 may be used to configure time-dependent transport properties of the objective species in the aquifer domain according to the species degradation data of the objective species, the geological characteristics data, and the flow field data corresponding to the aquifer domain, and the pollution source region of the aquifer domain. The time-dependent transport properties may include, but not limited to, groundwater velocity in the aquifer domain, dispersion rate of the objective species on X axis of the aquifer domain, dispersion rate of the objective species on Y axis of the aquifer domain, dispersion rate of the objective species on Z axis of the aquifer domain, decay rate throughout degradation path of the objective species, yield coefficient throughout degradation path of the objective species, retardation factor throughout degradation path of the objective species, and/or inlet boundary conditions of the objective species entering the aquifer domain via the pollution source region. Similarly, configurations of the time-dependent transport properties may also be displayed by the display module 500 for inspection by the user.

For example, in continuation to settings described in FIGS. 9 to 11, the groundwater velocity in the aquifer domain may be set as 30 m/year, the dispersion rate of the objective species on X axis of the aquifer domain may be set as 50 m²/year, the dispersion rate of the objective species on Y axis of the aquifer domain may be set as 5 m²/year, the dispersion rate of the objective species on Z axis of the aquifer domain may be set as 1 m²/year, the decay rate in degradation path of the objective species may be set as 0.075 for PCE, 0.07 for TCE, 0.02 for cis-1,2-DCE, 0.035 for trans-1,2-DCE, 0.055 for 1,1-DCE, 0.03 for VC, and 0.000001 for ETH, the yield coefficient in degradation path of the objective species may be set as 0.79 from PCE degrading to TCE, 0.74 from TCE degrading to DCE isomers, 0.64 from DCE isomers degrading to VC, and 0.45 from VC degrading to ETH 0.45, the retardation factor in degradation path of the objective species may be set as 7.13 for PCE, 2.87 for TCE, 2.80 for cis-1,2-DCE, 1.76 for trans-1,2-DCE, 1.85 for 1,1-DCE, 1.43 for VC, and 5.35 for ETH.

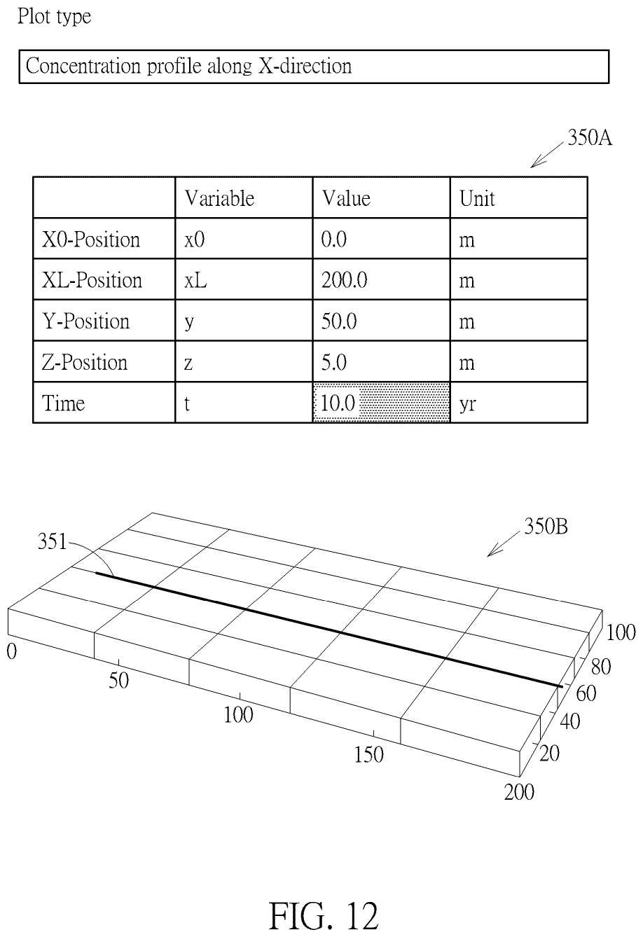

The output setting unit 350 may be used to configure output settings for the simulation output module 400 for simulating pollutant transportation within the aquifer domain. In the example shown in FIG. 12, the output settings are configured according to the settings of the aquifer domain in FIG. 10 and the pollution source region in FIG. 11, where interface 350A and interface 350B displayed by display module 500 may indicate that pollutant transportation of the objective species will be simulated along a line 351 extended from mid-point (e.g., position of origin on the X axis, 50 m on the Y axis and position of 5 m on Z axis of the Y-Z axis plane) of the pollution source region and parallel to the X axis of the aquifer domain, and the simulation is conducted throughout a period of 10 years.

In other examples, the pollutant transportation of the objective species may be configured to be simulated along any one of the three axes of the aquifer domain regardless of the positions of the pollution source region. Or, in a scenario where multiple objective species and/or multiple pollution source regions in the aquifer domain are configured for simulation, the output settings may be instead configured to have simulation carried out from respective pollution source regions of the aquifer domain simultaneously.

Further, the output setting unit 350 may also be used to configure other output settings. For example, the output settings may include a request for the simulation output module 400 to compute health risk factors and/or health risk scores for living creatures residing in the area of the specified location and/or the aquifer domain. The health risk factors and/or health risk scores may present as carcinogenic risk and/or non-carcinogenic risk of a living creature with respect to exposure time to the objective species, water intake, and weight.

Based on the above, the simulation setting module 300 may further generate the objective species and the species degradation data generated by the species setting unit 310, the aquifer domain generated by the aquifer setting unit 320, the pollution source region generated by the pollution source setting unit 330, the time-dependent transport properties of the objective species generated by the pollution transport setting unit 340, and the output settings generated by the output setting unit 350 as the simulation setting data and transmit to the simulation output module 400 for further processing.

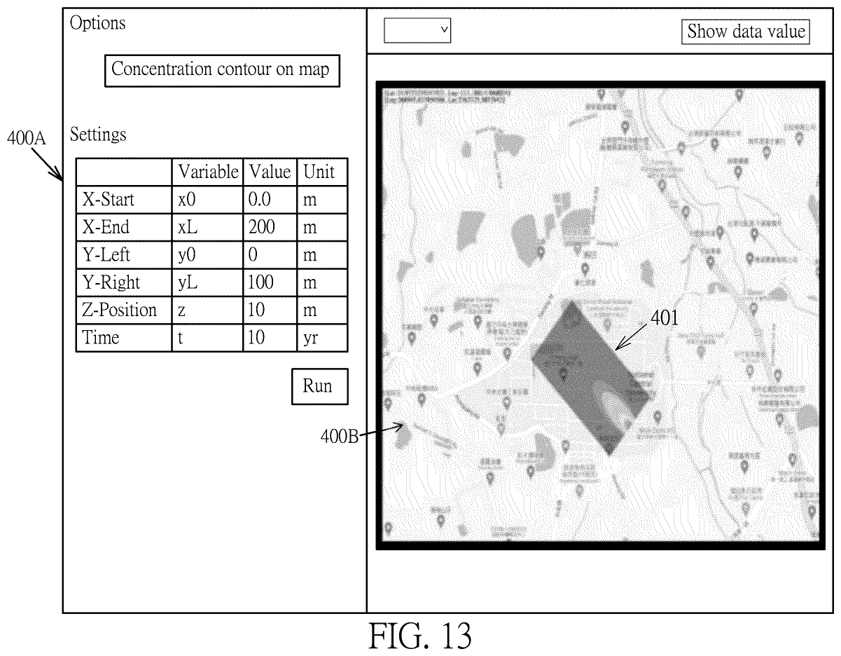

The simulation output module 400 is coupled to the simulation setting module 300 and may be used to generate simulation output data according to the simulation setting data. The detail of the simulation output module 400 generating simulation output data may be understood through the following description and FIG. 13.

When simulating one-dimensional variation of objective species within the three-dimensional space of the aquifer domain using the configuration indicated in FIG. 12, the simulation output module 400 may compute the objective species, the species degradation data, the aquifer domain, the pollution source region, the time-dependent transport properties of the objective species and the output settings of the simulation setting data for simulation based on the following general equation:

$$D \frac{{\partial }^{2} {C}_{1} ( x , t )}{\partial {x}^{2}} - v \frac{\partial {C}_{i} ( x , t )}{\partial x} - {μ}_{i} {C}_{i} ( x , t ) = {R}_{i} \frac{\partial {C}_{i} ( x , t )}{\partial x} , \qquad equation 1$$

Where D is the hydrodynamic dispersion coefficient, v is the average pore-water velocity, Cᵢ(x,t) is the aqueous concentration of the contaminant at a (i)th decay level in the degradation pathway of the species degradation data, x is the spatial coordinate on x axis of the aquifer domain, t is time, μᵢ is the first-order decay rate for contaminant at a (i)th decay level, Rᵢ is the retardation factor for contaminant at a (i)th decay level.

Further, retardation factor Rᵢ may be expressed in the following equation:

$${R}_{i} = 1 + \frac{{ρ}_{b} {K}_{oc , i}}{{f}_{oc} θ} , \qquad equation 2$$

Where ρ_{b} is the bulk density of the aquifer domain, K_{oc,i} is the organic-water partitioning coefficient for contaminant at a (i)th decay level, f_{oc} is the organic carbon fraction, and θ is the porosity of the aquifer domain.

For each contaminant of the species degradation data of the objective species, other factors may also be included for simulation. For example, yield coefficient g_{i-1→i} may be considered for computing mass conversion from a parent contaminant at a (i−1)th decay level to a daughter contaminant at (i)th decay level in a one-to-one relationship of a degradation pathway. In another example, branching ratio fⱼᵢ may be considered for computing divergent transformation from a parent contaminant at (i−1)th decay level to a (j)th daughter contaminant at a (i)th decay level in a one-to-many/many-to-one relationship of a degradation pathway. In a further example, inlet boundary conditions of the objective species entering the aquifer domain via the pollution source region may be incorporated in response to the inlet boundary condition being a first-type boundary condition or a third-type boundary condition. The first-type boundary condition meaning the concentration of the objective species is fixed at the pollution source region, and may be expressed as the following equation:

$${C}_{i} ( x = 0 , t ) = {C}_{i , 0} , \qquad equation 3$$

where C_{i,0} is the inlet source concentration of a contaminant at a (i)th decay level of the degradation pathway of the objective species. The third-type boundary condition meaning the concentration of the objective species at the pollution source region is related to the flow dynamics of the aquifer domain, and may be expressed as the following equation:

$$- D \frac{\partial {C}_{1} ( x = 0 , t )}{\partial x} + {vC}_{i} ( x = 0 , t ) = {vC}_{i , 0} , \qquad equation 4$$

where D is the dispersion coefficient, and v is the average pore-water velocity.

Therefore, when the objective species is configured to be a chlorinated solvent “PCE,” and the complex degradation pathway of PCE in FIG. 9 is configured for simulation, analytical solutions for simulating one-dimensional variation of PCE may be expressed as follows:

$$D \frac{{\partial }^{2} {C}_{1} ( x , t )}{\partial {x}^{2}} - v \frac{\partial {C}_{1} ( x , t )}{\partial x} - {μ}_{1} {C}_{1} ( x , t ) = {R}_{1} \frac{\partial {C}_{1} ( x , t )}{\partial x} , \qquad equation 5$$

$$D \frac{{\partial }^{2} {C}_{2} ( x , t )}{\partial {x}^{2}} - v \frac{\partial {C}_{2} ( x , t )}{\partial x} - {μ}_{2} {C}_{2} ( x , t ) + {g}_{P \to T} {μ}_{1} {C}_{1} ( x , t ) = {R}_{2} \frac{\partial {C}_{2} ( x , t )}{\partial t} , \qquad equation 6$$

$$D \frac{{\partial }^{2} {C}_{13} ( x , t )}{\partial {x}^{2}} - v \frac{\partial {C}_{13} ( x , t )}{\partial x} - {μ}_{13} {C}_{13} ( x , t ) + {f}_{13} {g}_{T \to D} {μ}_{2} {C}_{2} ( x , t ) = {R}_{13} \frac{\partial {C}_{13} ( x , t )}{\partial t} , \qquad equation 7$$

$$D \frac{{\partial }^{2} {C}_{23} ( x , t )}{\partial {x}^{2}} - v \frac{\partial {C}_{23} ( x , t )}{\partial x} - {μ}_{23} {C}_{23} ( x , t ) + {f}_{23} {g}_{T \to D} {μ}_{2} {C}_{2} ( x , t ) = {R}_{23} \frac{\partial {C}_{23} ( x , t )}{\partial t} , \qquad equation 8$$

$$D \frac{{\partial }^{2} {C}_{33} ( x , t )}{\partial {x}^{2}} - v \frac{\partial {C}_{33} ( x , t )}{\partial x} - {μ}_{33} {C}_{33} ( x , t ) + {f}_{33} {g}_{T \to D} {μ}_{2} {C}_{2} ( x , t ) = {R}_{33} \frac{\partial {C}_{33} ( x , t )}{\partial t} , \qquad equation 9$$

$$D \frac{{\partial }^{2} {C}_{4} ( x , t )}{\partial {x}^{2}} - v \frac{\partial {C}_{4} ( x , t )}{\partial x} - {μ}_{4} {C}_{4} ( x , t ) + {g}_{D \to V} {μ}_{13} {C}_{13} ( x , t ) + {g}_{D \to V} {μ}_{23} {C}_{23} ( x , t ) + {g}_{D \to V} {μ}_{33} {C}_{33} ( x , t ) = {R}_{4} \frac{\partial {C}_{4} ( x , t )}{\partial t} , \qquad equation 10$$

$$D \frac{{\partial }^{2} {C}_{5} ( x , t )}{\partial {x}^{2}} - v \frac{\partial {C}_{5} ( x , t )}{\partial x} - {μ}_{5} {C}_{5} ( x , t ) + {g}_{V \to E} {μ}_{4} {C}_{4} ( x , t ) = {R}_{5} \frac{\partial {C}_{5} ( x , t )}{\partial t} , \qquad equation 11$$

where C₁ corresponds to PCE at 1st decay level, C₂ corresponds to TCE at 2nd decay level, C₁₃ corresponds to cis-1,2-DCE at 3rd decay level, C₂₃ corresponds to trans-1,2-DCE at 3rd decay level, C₃₃ corresponds to 1,1-DCE at 3rd decay level, C₄ corresponds to VC at 4th decay level, and C₅ corresponds to ETH at 5th decay level.

Based on the above, when simulating the three-dimensional transportation of objective species (e.g., PCE) within the three-dimensional space of the aquifer domain using the configuration indicated in FIG. 12, since transportation of the objective species on all three axes of the aquifer domain should be considered simultaneously, the above analytical solution may be further altered based on the following general equation:

$${\sum }_{{k}_{i - 1} = 1}^{{n}_{i - 1}} {f}_{( i - 1 ) {k}_{i - 1} \to ji} {g}_{i - 1 \to i} {μ}_{( i - 1 ) {k}_{i - 1}} {R}_{( i - 1 ) {k}_{i - 1}} {C}_{( i - 1 ) {k}_{i - 1}} ( x , y , z , t ) = {R}_{ji} \frac{\partial {C}_{ji} ( xy , z , t )}{\partial t} , \qquad equation 12$$

where Dₓ, D_{y}, and D_{z} represent the three different dispersion coefficients in the x-axis, y-axis, and z-axis directions of the aquifer domain, respectively, and x, y, and z are the spatial coordinates of x axis, y axis, and z axis of the aquifer domain, respectively.

In continuation to the example shown in FIGS. 9 to 12 and referring to the analytical solution as described above, FIG. 13 describes the simulation output data generated by simulation output module 400 and displayed by the display module 500. Here, interface 400A may indicate the configurations of all settings configured by the simulation setting module 300 for simulation (as those shown in FIGS. 9 to 12), and interface 400B may indicate the simulation output data may be displayed on the map of the area of the specified location, where aquifer domain 401 is labeled to have various colored regions with respect to transportation time, with red being the region with higher concentration of the objective species or contaminant result from degradation through time, and blue being the region with lower concentration of the objective species or contaminant result from degradation through time.

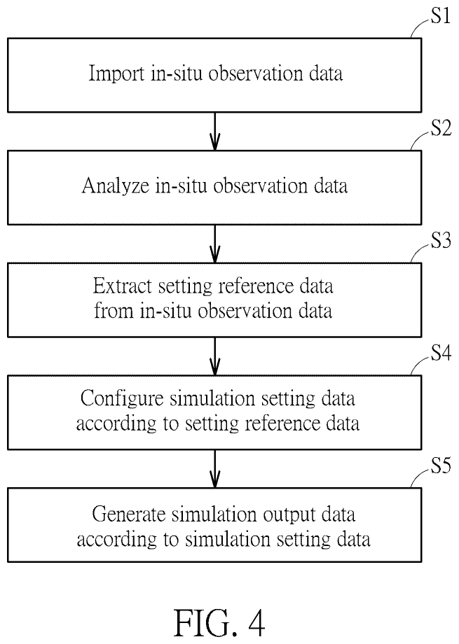

In sum, FIG. 4 is a flow chart explaining the overall steps in performing a simulation of pollutant transportation for an objective species via the system for simulating pollutant transportation 1, which includes:
S1: the import module 100 imports in-situ observation data;
S2: the analysis module 200 analyzes the in-situ observation data;
S3: the analysis module 200 extracts the setting reference data from the in-situ observation data;
S4: the simulation setting module 300 configures the simulation setting data according to the setting reference data; and
S5: the simulation output module 400 generates the simulation output data according to the simulation setting data.

Based on the above, the system and method for simulating pollutant transportation are beneficial in providing accurate simulation of pollutant transportation by adapting to different types of pollutants and environmental conditions, and are convenient for more accurate and timely decision-making in pollution control and environmental management.

Those skilled in the art will readily observe that numerous modifications and alterations of the embodiments may be made while retaining the teachings of the invention. Accordingly, the above disclosure should be construed as limited only by the metes and bounds of the appended claims.

What is claimed is:

1. A system for simulating pollutant transportation, comprising:
an import module configured to import in-situ observation data;
an analysis module coupled with the import module and configured to analyze the in-situ observation data and extract setting reference data from the in-situ observation data;
a simulation setting module coupled with the analysis module and configured to generate simulation setting data according to the setting reference data; and
a simulation output module coupled with the simulation setting module and configured to generate simulation output data according to the simulation setting data.

2. The system of claim 1, wherein:
the in-situ observation data comprises drill core data, water level observation data, and pollutant concentration observation data of a specified location;
the analysis module comprises:
a geological determination unit configured to analyze the drill core data to generate geological characteristics data of the specified location;
an hydrology determination unit configured to analyze the water level observation data to generate flow field data of the specified location; and
a species determination unit configured to analyze the pollutant concentration observation data to generate species concentration distribution data of the specified location; and
the analysis module is further configured to generate the geological characteristics data, the flow field data, and the species concentration distribution data as the setting reference data.

3. The system of claim 2, wherein:
the simulation setting module comprises:
a species setting unit configured to configure an objective species and generate species degradation data of the objective species according to the species concentration distribution data of the specified location;
an aquifer setting unit configured to configure an aquifer domain of the specified location according to the geological characteristics data and the flow field data of the specified location;
a pollution source setting unit configured to configure a pollution source region of the objective species within the aquifer domain according to the species concentration distribution data of the objective species and the aquifer domain;
a pollution transport setting unit configured to configure time-dependent transport properties of the objective species in the aquifer domain according to the species degradation data of the objective species, the geological characteristics data and the flow field data corresponding to the aquifer domain, and the pollution source region of the objective species within the aquifer domain; and
an output setting unit configured to configure output settings according to the aquifer domain and the pollution source region of the objective species within the aquifer domain; and
the simulation setting module is further configured to generate the objective species, the species degradation data, the aquifer domain, the pollution source region, and the time-dependent transport properties of the objective species as the simulation setting data.

4. The system of claim 3, wherein the time-dependent transport properties of the objective species in the aquifer domain comprises at least one selected from the group consisting of groundwater velocity in the aquifer domain, dispersion rate of the objective species on X axis of the aquifer domain, dispersion rate of the objective species on Y axis of the aquifer domain, dispersion rate of the objective species on Z axis of the aquifer domain, decay rate throughout degradation path of the objective species, yield coefficient throughout the degradation path of the objective species, retardation factor throughout the degradation path of the objective species, and inlet boundary conditions of the objective species entering the aquifer domain via the pollution source region.

5. The system of claim 3, wherein:
the objective species is a chlorinated solvent;
the species degradation data of the objective species comprises a complex degradation pathway of the chlorinated solvent; and
the aquifer domain is a three-dimensional domain.

6. The system of claim 1, further comprising:
a display module coupled with the simulation output module and configured to display the simulation output data on a map.

7. A method for simulating pollutant transportation, comprising:
an import module importing in-situ observation data;
an analysis module analyzing the in-situ observation data and extracting setting reference data from the in-situ observation data;
a simulation setting module generating simulation setting data according to the setting reference data; and
a simulation output module generating simulation output data according to the simulation setting data.

8. The method of claim 7, wherein:
the in-situ observation data comprises drill core data, water level observation data, and pollutant concentration observation data of a specified location; and
the analysis module analyzing the in-situ observation data and extracting the setting reference data from the in-situ observation data comprises:
a geological determination unit of the analysis module analyzing the drill core data to generate geological characteristics data of the specified location;
an hydrology determination unit of the analysis module analyzing the water level observation data to generate flow field data of the specified location;
a species determination unit of the analysis module analyzing the pollutant concentration observation data to generate species concentration distribution data of the specified location; and
the analysis module generating the geological characteristics data, the flow field data, the species concentration distribution data as the setting reference data.

9. The method of claim 8, wherein the simulation setting module generating simulation setting data according to the setting reference data comprises:
a species setting unit of the simulation setting module configuring an objective species and generating species degradation data of the objective species according to the species concentration distribution data of the specified location;
an aquifer setting unit of the simulation setting module configuring an aquifer domain of the specified location according to the geological characteristics data and the flow field data of the specified location;
a pollution source setting unit of the simulation setting module configuring a pollution source region of the objective species within the aquifer domain according to the species concentration distribution data and the aquifer domain;
a pollution transport setting unit of the simulating setting module configuring time-dependent transport properties of the objective species in the aquifer domain according to the species degradation data of the objective species, the geological characteristics data and the flow field data corresponding to the aquifer domain, and the pollution source region of the objective species within the aquifer domain; and
an output setting unit of the simulating setting module configuring output settings according to the aquifer domain and the pollution source region of the objective species within the aquifer domain; and
the simulation setting module generating the objective species, the species degradation data, the aquifer domain, the pollution source region, and the time-dependent transport properties of the objective species as the simulation setting data.

10. The method of claim 9, wherein the time-dependent transport properties of the objective species in the aquifer domain comprises at least one selected from the group consisting of groundwater velocity in the aquifer domain, dispersion rate of the objective species on X axis of the aquifer domain, dispersion rate of the objective species on Y axis of the aquifer domain, dispersion rate of the objective species on Z axis of the aquifer domain, decay rate throughout degradation path of the objective species, yield coefficient throughout the degradation path of the objective species, retardation factor throughout the degradation path of the objective species, and inlet boundary conditions of the objective species entering the aquifer domain via the pollution source region.

11. The method of claim 9, wherein:
the objective species is a chlorinated solvent;
the species degradation data of the objective species comprises a complex degradation pathway of the chlorinated solvent; and
the aquifer domain is a three-dimensional domain.

12. The method of claim 7, further comprising:
a display module displaying the simulation output data on a map.
